(19) United States
(12) Patent Application Publication
(10) Pub. No.: US 2010/0332236 A1
(43) Pub. Date: Dec. 30, 2010

(54) VOICE-TRIGGERED OPERATION OF ELECTRONIC DEVICES

(75) Inventor: Adrian Tan, Melbourne (AU)

Correspondence Address: FLIESLER MEYER LLP, 650 CALIFORNIA STREET, 14TH FLOOR, SAN FRANCISCO, CA, 94108, US

(73) Assignee: BLUEANT WIRELESS PTY LIMITED, Richmond (AU)

(21) Appl. No.: 12/822,011

(22) Filed: Jun. 23, 2010

Related U.S. Application Data
(60) Provisional application No. 61/316,291, filed on Mar. 22, 2010.
(60) Provisional application No. 61/220,399, filed on Jun. 25, 2009.
(60) Provisional application No. 61/220,435, filed on Jun. 25, 2009.

(51) Int. Cl. G10L 11/00

(52) U.S. Cl. 704/275; 704/E11.001

(57) ABSTRACT

A system and method operating features of telecommunications, audio headsets, speakers, and other communications and electronic devices, such as mobile telephones, personal digital assistants and cameras, using voice-activated, voice-trigged or voice-enabled operation. In accordance with an embodiment, the electronic device is capable of operating in an idle mode, in which the device listens for verbal commands from a user. When the user speaks or otherwise issues a command, the device recognizes the command and responds accordingly, including, depending on the context in which the command is issued, following a series of prompts to guide the user through operating one or more features of the device, such as accessing menus or other features. In accordance with an embodiment, this allows the user to operate the device in a hands-free mode if desired.

### CLAIM OF PRIORITY

This application claims the benefit of priority to U.S. Provisional Patent Application No. 61/316,291 titled “VOICE-TRIGGERED OPERATION OF ELECTRONIC DEVICES”, filed Mar. 22, 2010; U.S. Provisional Patent Application No. 61/220,399 titled “TELECOMMUNICATIONS DEVICE WITH VOICE-CONTROLLED FUNCTIONS”, filed Jun. 25, 2009; and U.S. Provisional Patent Application No. 61/220,435 titled “VOICE-ENABLED WALK-THROUGH PAIRING OF TELECOMMUNICATIONS DEVICES”, filed Jun. 25, 2009; each of which applications are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The invention is generally related to telecommunications, audio headsets, speakers, and other communications and electronic devices, such as mobile telephones, personal digital assistants and cameras, and is particularly related to a system and method for operating features of such devices using voice-activated, voice-trigged or voice-enabled operation.

### BACKGROUND

The use of telecommunications, audio headsets, speakers, and other communications and electronic devices, such as mobile telephones, personal digital assistants and cameras, continues to become more widespread, and business and casual users commonly have one or more, and in some instances several such devices. However, the features of each of these devices are typically operated using a combination of different buttons and controls, which can be complicated and unwieldy, and vary substantially between different manufacturers. In particular, complex features that may require multiple steps to invoke, such as pairing a Bluetooth-enabled headset with a Bluetooth-enabled mobile telephone, can be difficult for some, especially novice users. This is the general area that embodiments of the invention are intended to address.

### SUMMARY

Disclosed herein is a system and method operating features of telecommunications, audio headsets, speakers, and other communications and electronic devices, such as mobile telephones, personal digital assistants and cameras, using voice-activated, voice-trigged or voice-enabled operation. In accordance with an embodiment, the electronic device is capable of operating in an idle mode, in which the device listens for verbal commands from a user. When the user speaks or otherwise issues a command, the device recognizes the command and responds accordingly, including, depending on the context in which the command is issued, following a series of prompts to guide the user through operating one or more features of the device, such as accessing menus or other features. In accordance with an embodiment, this allows the user to operate the device in a hands-free mode if desired.

### BRIEF DESCRIPTION OF THE DRAWINGS

FIG. 1 shows an illustration of a headset, speakerphone, or other communications or electronic device, such as a mobile telephone, personal digital assistant or camera that provides voice-activated, voice-trigged or voice-enabled operation, in accordance with an embodiment.

FIG. 2 shows an illustration of a system for providing voice-activated, voice-trigged or voice-enabled functionality in a telecommunications device, in accordance with an embodiment.

FIG. 3 is a flowchart of a method for providing voice-activated, voice-trigged or voice-enabled operation in a device, in accordance with an embodiment.

FIG. 4 shows an illustration of a mobile telephone and a headset that includes voice-activated, voice-trigged or voice-enabled operation, in accordance with an embodiment.

### DETAILED DESCRIPTION

Described herein is a system and method operating features of telecommunications, audio headsets, speakers, and other communications and electronic devices, such as mobile telephones, personal digital assistants and cameras, using voice-activated, voice-trigged or voice-enabled operation. As described above, the use of telecommunications, audio headsets, speakers, and other communications and electronic devices, such as mobile telephones, personal digital assistants and cameras, continues to become more widespread. However, the features of each of these devices can be complicated and unwieldy, and vary substantially between different manufacturers; and complex features may require multiple steps to invoke. In accordance with an embodiment, the electronic device is capable of operating in an idle mode, in which the device listens for verbal commands from a user. When the user speaks or otherwise issues a command, the device recognizes the command and responds accordingly, including, depending on the context in which the command is issued, following a series of prompts to guide the user through operating one or more features of the device, such as accessing menus or other features. In accordance with an embodiment, this allows the user to operate the device in a hands-free mode if desired.

An example of a complex feature is the pairing of a Bluetooth-enabled headset with a Bluetooth-enabled mobile telephone. In this example, pairing is generally performed by exchanging a passkey between two Bluetooth devices, which confirms that the devices (or the users of the devices) have agreed to pair with each other. Typically, pairing begins with a first device being configured to look for other devices in its immediate vicinity; and a second Bluetooth device being configured to advertise its presence to other devices in its immediate vicinity. When the two devices discover one another, they can prompt for the entry of a passkey, which must match at either device to allow a pair to be created. Some devices, for example some audio headsets, have a factory pre-set passkey, which cannot be changed by a user, but must be entered into the device being paired with. As such, the pairing process is often quite complex, and an unfamiliar task for novice users.

Copending U.S. Provisional Patent Applications “TELECOMMUNICATIONS DEVICE WITH VOICE-CONTROLLED FUNCTIONS”, Application No. 61/220,399, filed Jun. 25, 2009; and “VOICE-ENABLED WALK-THROUGH PAIRING OF TELECOMMUNICATIONS DEVICES”, Application No. 61/220,435, filed Jun. 25, 2009, each of which applications are incorporated by reference herein, provide examples of a headset that can operate in an always-listening or passively-listening voice recognition mode, including receiving voice commands from a user, such as a request from the user to “Pair Me”, and then guiding the user through the pairing process. As described in that example, a typical pairing script can include, for example:
Headset: “The headset is now in Pair mode, ready to connect to your phone. Go to the Bluetooth Menu on your phone.”
Device waits 3 seconds; then plays pairMe1.wav (or equivalent verbal/audio notification).
Headset: “Turn On or Enable Bluetooth.”
Device waits 5 seconds; then plays pairMe2.wav (or equivalent verbal/audio notification).
Headset: “Select Pair or add New device.”
Device waits 3 seconds; then plays pairMe3.wav (or equivalent verbal/audio notification).
Headset: “Select the <Phone Name>”
Device waits 3 seconds; then plays pairMe4.wav (or equivalent verbal/audio notification).
Headset: “On your phone enter 0 0 0 0. Accept any connection requests and enable automatic connection. If required set the <Phone Name> as a trusted device in the Options menu.”
Device plays pairMe5.wav (or equivalent verbal/audio notification).

Using such a pairing script a device, such as a headset, can search for discoverable pairs. If no discoverable pair is found, then, the device verbally notifies the user accordingly. If a discoverable pair is found, the device confirms that the correct passkey has been entered into the telephone, pairs the device with the telephone, and verbally notifies the user of the successful pairing.

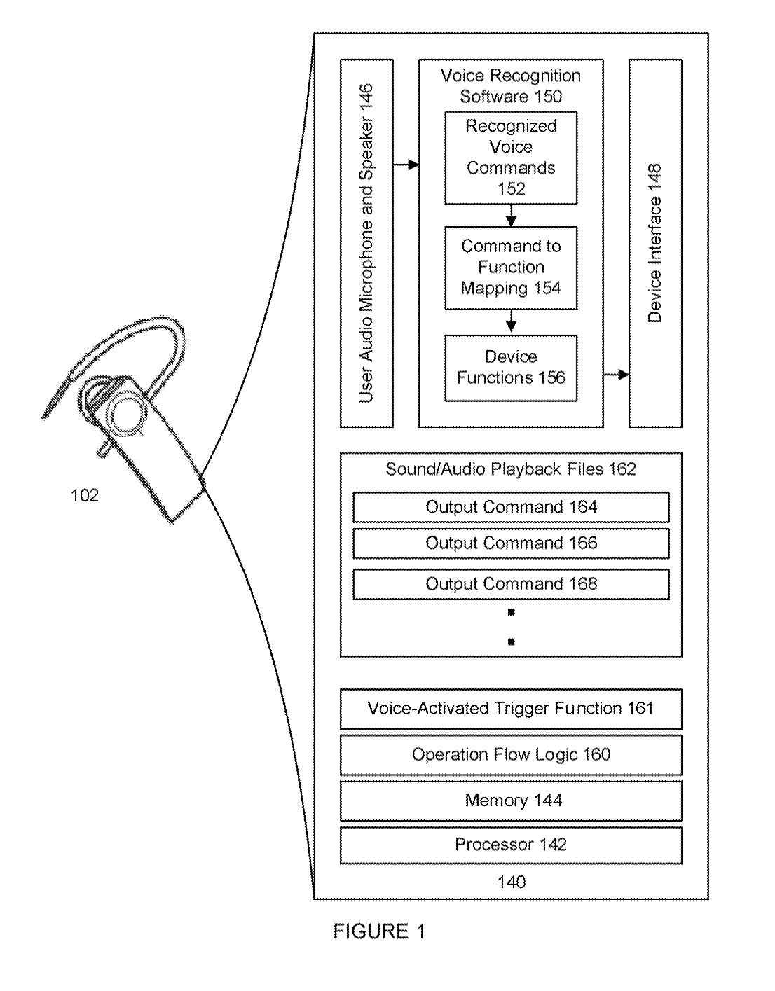

FIG. 1 shows an illustration of a headset, speakerphone, or other communications or electronic device, such as a mobile telephone, personal digital assistant or camera that provides voice-activated, voice-trigged or voice-enabled operation, in accordance with an embodiment. As shown in FIG. 1, the headset, speakerphone, or other communications or electronic device 102 can include an embedded circuitry or logic 140 including a processor 142, memory 144, user audio microphone and speaker 146, and device interface 148. A voice recognition software 150 includes programming that recognizes voice commands 152 from the user, maps the voice commands to a list of available functions 154, and prepares corresponding device functions 156 for communication to the telephone or other device via the telecommunications device interface. An operation flow logic 160 together with a voice-activated trigger function 161 and a plurality of sound/audio playback files and/or script of output commands 164, 166, 168, such as way files, can be used to provide voice-enabled operation, including notifications or instructions to a user.

In accordance with an embodiment, the voice-activated trigger function is associated with a software flag or similar indicator that can be switched to indicate that the voice-activated trigger function is set to an on (enabled) or off (disabled) mode. When the voice-activated trigger function is on or enabled, the system continuously activates microphone listening and is ready to perform voice recognition, regardless of whether the main button is depressed. When the voice-activated trigger function is off or disabled, the system only activates microphone listening and/or initiates voice recognition when a manually-operated feature, such as a main button, is depressed or otherwise activated; at which point the system issues an acknowledgement such as “Say a command” and enters full voice recognition mode.

In accordance with an embodiment, when the voice-activated trigger function is in the on or enabled mode, the system activates microphone listening, but waits until it receives a previously configured specific phrase or command as a voice trigger, for example “Activate”, “Speak to me”, or other configured phrase or command, before issuing an acknowledgement such as “Say a command” and entering full voice recognition mode.

Each of the above components can be provided on or combined into one or more integrated circuits or electronic chips in a small form factor for fitting within a headset or other electronic device.

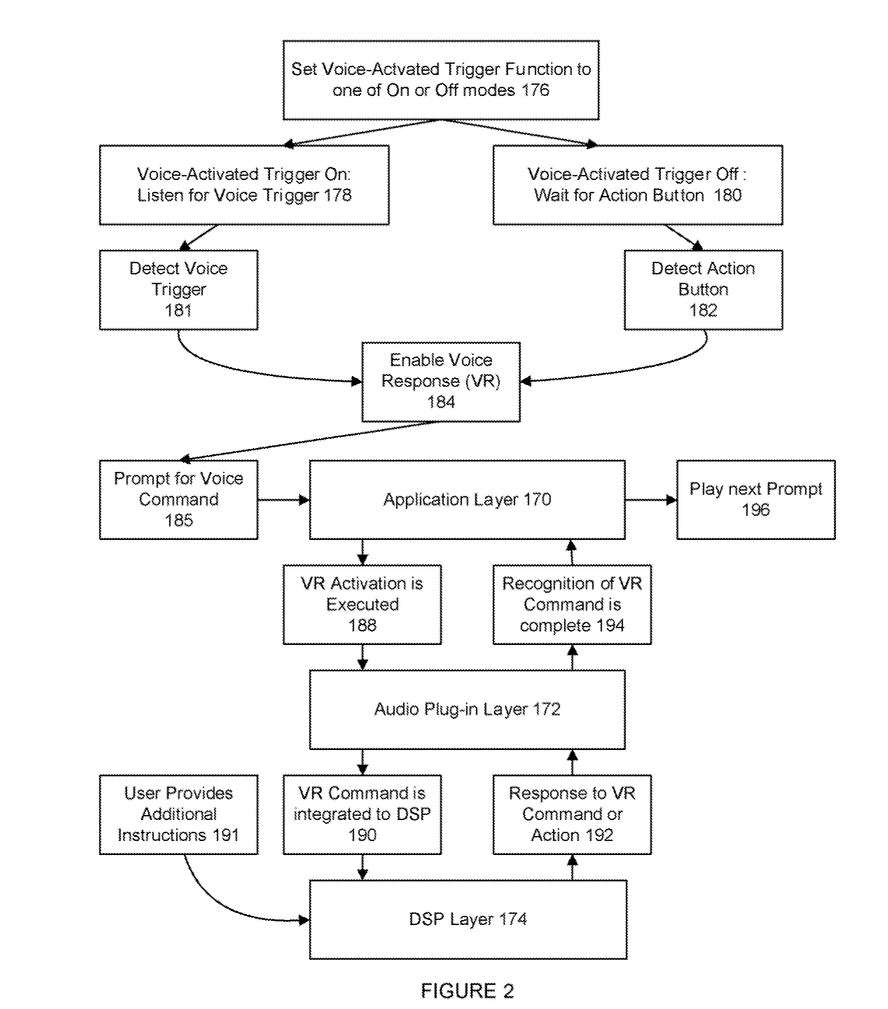

FIG. 2 shows an illustration of a system for providing voice-activated, voice-trigged or voice-enabled functionality in a telecommunications device, in accordance with an embodiment. As shown in FIG. 2 in accordance with an embodiment the system comprises an application layer 170, audio plug-in layer 172, and DSP layer 174. The application layer provides the logic interface to the user, and allows the system to be enabled for voice responses (VR), for example by monitoring the use of an action button, or when the voice-activated function is enabled by listening for a spoken command from a user. In accordance with an embodiment, the voice-activated trigger function is associated with a software flag or similar indicator 176 that can be switched to indicate that the voice-activated trigger function is set in one of an on (enabled) or off (disabled) mode.

When the voice-activated trigger function is off or disabled 180, the system only activates microphone listening and/or initiates voice recognition when a manually-operated feature, such as a main button, is depressed or otherwise activated 182. The system then enters full voice recognition mode 184 and/or issues an acknowledgement 185, such as ‘Say a Command”.

When the voice-activated trigger function is on or enabled 178, the system activates microphone listening, but waits until it receives a specific phrase or command as a voice trigger 181, such as an instruction from the user to “Speak to me”. The system then similarly enters full voice recognition mode 184 and/or issues an acknowledgement 185, such as ‘Say a Command”.

In each case, when VR is activated 188 as appropriate and dependant on the voice-activated trigger function setting, the user input is subsequently provided to the audio plug-in layer that provides voice recognition and/or translation of the command to a format understood by the underlying DSP layer. In accordance with different embodiments, different audio layer components can be plugged-in, and/or different DSP layers. This allows an existing application layer to be used with new versions of audio layer and/or DSP, for example in different telecommunications products. The output of the audio layer is integrated within the DSP 190, together with any additional or optional instructions from the user 191. The DSP layer is then responsible for communicating with other telecommunications device. In accordance with an embodiment, the DSP layer can utilize a Kalimba CSR BC05 chipset, which provides for Bluetooth interoperability with Bluetooth-enabled telecommunications devices. In accordance with other embodiments, other types of chipset can be used. The DSP layer then generates a response to the VR command or action 192, or performs a necessary operation, such as a Bluetooth operation, and the audio layer instructs the application layer of the completed command 194. At this point, the application layer can play additional prompts and/or receive additional commands 196 as necessary. Each of the above components can be combined and/or provided as one or more integrated software and/or hardware configurations.

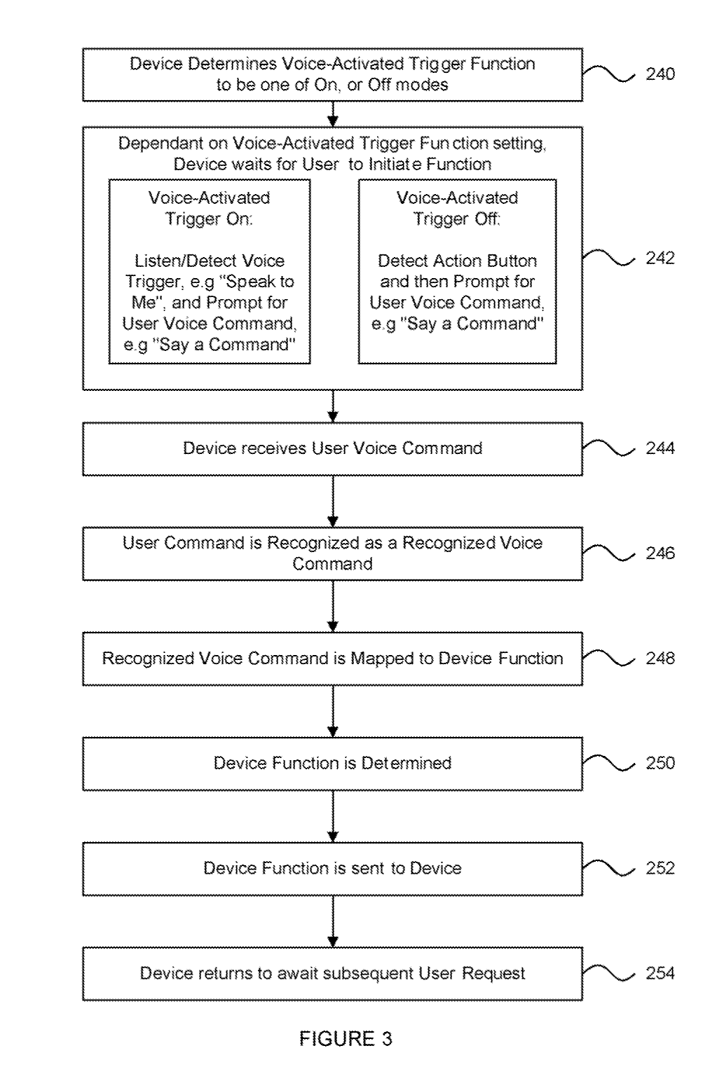

FIG. 3 is a flowchart of a method for providing voice-activated, voice-trigged or voice-enabled operation in a device, in accordance with an embodiment. As shown in FIG. 3, in step 240, the voice-activated trigger feature of the device can be in either an on (enabled), or off (disabled) mode, as determined by a voice-activated trigger function. In step 242, depending on the mode, the device waits for, or is activated, or triggered to receive a user voice command. As described above, when the voice-activated trigger function is on or enabled, the system waits until it receives a specific phrase or command as a voice trigger; whereas when the voice-activated trigger function is off or disabled, the system only initiates voice recognition when a manually-operated feature, such as a main button, is depressed or otherwise activated. In step 244 a voice command is received. In step 246, the voice command is recognized and, in step 248, mapped to one or more device functions, such as requesting the telephone dial a particular number, or initiating a pairing sequence. In step 250, the device function is determined In step 252, the device function is sent to the device and, in step 254, the device returns to await subsequent user requests.

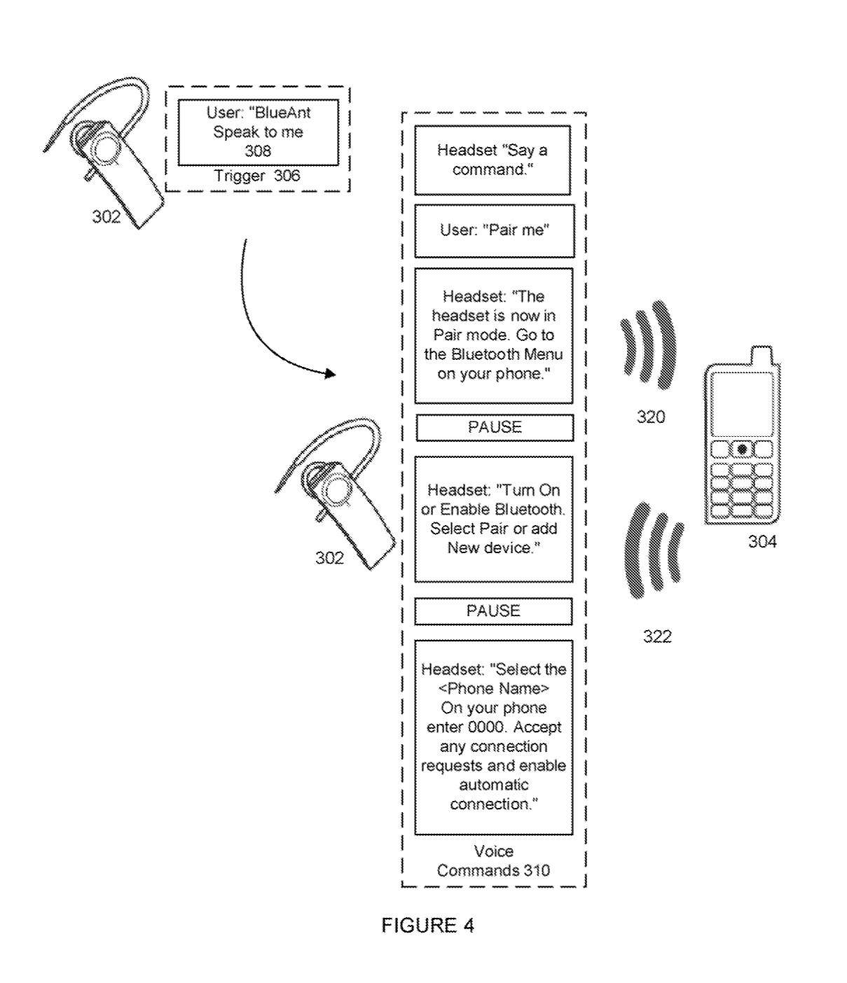

FIG. 4 shows an illustration of a mobile telephone and a headset that includes voice-activated, voice-trigged or voice-enabled operation, in accordance with an embodiment. In particular, FIG. 4 shows an example of using voice-activated, voice-trigged or voice-enabled operation to pair a headset 302 with a mobile telephone 304, such as with Bluetooth. As shown in FIG. 4, if the device is in a voice-activated trigger on or enabled mode, a user can utter a voice trigger 306, such as “BlueAnt speak to me” 308, to cause the device to enter voice recognition mode and to await further commands 310, such as dialing a number using the mobile telephone or starting the pairing process. Depending on the function requested, a Bluetooth or other signal 320 can be sent to the mobile telephone to activate a function thereon. The headset can provide prompts to the user, asking them to perform some additional actions to complete the process. Information can also be received from the mobile telephone, again using a Bluetooth or other signal 322. When the process is complete, the headset can notify the user with another aural response and in this example, pair the headset with the mobile telephone.

The foregoing description of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. For example, voice control. It is intended that the scope of the invention be defined by the following claims and their equivalence.

Some aspects of the present invention may be conveniently implemented using one or more conventional general purpose or specialized digital computer, computing device, machine, microprocessor, or electronic circuits, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

What is claimed is:

1. A system for providing voice-triggered or voice-enabled operation of an electronic device, comprising:
an electronic device, such as a headset, camera or mobile phone or other device, having an embedded circuitry or logic including a processor, memory, and user audio microphone;
a voice-activated trigger function that determines whether the device responds to verbal inputs as a voice-activated trigger; and
a voice recognition logic that waits to receive a specific phrase or command as a voice-activated trigger voice trigger, and upon being triggered, plays a script of instructions or notifications to assist the user in operating features of the electronic device.

2. A method for providing voice-triggered or voice-enabled operation of an electronic device, comprising the steps of:
providing an electronic device, such as a headset, camera or mobile phone or other device having an embedded circuitry or logic including a processor, memory, and user audio microphone;
providing a voice-activated trigger flag that determines whether the device responds to voice-activated triggers;
waiting to receive a specific phrase or command as a voice-activated trigger voice trigger; and
playing a script of instructions or notifications to assist the user in operating features of the electronic device.
